(19) United States
(12) Patent Application Publication
(10) Pub. No.: US 2026/0360078 A1
(43) Pub. Date: Nov. 12, 2026

(54) TECHNIQUES FOR GENERATING VIRTUAL ENVIRONMENTS BASED ON REAL-TIME EVENTS

(71) Applicant: DISNEY ENTERPRISES, INC., Burbank, CA (US)

(72) Inventors: Alif KHALFAN, Redwood City, CA (US); Malcolm MURDOCK, Santa Clarita, CA (US); Tatiana Marie VAZ, Los Angeles, CA (US)

(21) Appl. No.: 19/205,849

(22) Filed: May 12, 2025

(51) Int. Cl. G06T 17/00; G06N 20/00; G06T 13/20

(52) U.S. Cl. CPC G06T 17/00; G06N 20/00; G06T 13/20

(57) ABSTRACT

A computer-implemented technique for generating a virtual environment includes receiving one or more real-time feeds and one or more user inputs, generating, using a first trained machine learning model and based on the one or more real-time feeds and the user input, a description of a virtual environment state, generating, based on the description of the virtual environment state, the virtual environment, and outputting the virtual environment via at least one output device.

### BACKGROUND

### Field of the Various Embodiments

The various embodiments relate generally to computer science, artificial intelligence (AI), and machine learning and, more specifically, to techniques for generating virtual environments based on real-time events.

### Description of the Related Art

Virtual environments are computer-simulated spaces in which users can interact with objects, characters, and/or settings through a user interface or immersive technology. For example, a fantasy game could include a virtual kingdom with castles, forests, and villages populated by unique characters, each with a backstory. As another example, a science fiction simulation could include alien planets with unfamiliar terrain, weather systems, and technologically advanced societies. As a further example, an educational application could include interactive historical environments that allow users to explore ancient cities or reenact historical events.

One conventional approach for creating virtual environments is to manually program the virtual environments, including the objects, characters, settings, etc. in those virtual environments. For example, designers can manually create every part of virtual environments and write fixed scripts for behaviors in the virtual environments. Recent advances in artificial intelligence (AI), especially generative AI models, have permitted computers to generate large, detailed, and even imaginative virtual worlds. For example, some generative AI models are able to generate the next frame of a video game environment given a current frame and user actions as input.

One drawback of conventional approaches for creating virtual environments, including using generative AI models, is that the generated virtual environments typically cannot be changed in response to real-time events occurring outside the virtual environments. Instead, once a virtual environment is programmed by a developer or a generative AI model for generating a virtual environment is trained, the resulting virtual environment, including the objects, characters, and settings therein, remain fixed, regardless of new developments or real-time events in the real world. For example, a game or simulation environment cannot automatically update a storyline within the environment to reflect the outcome of a live sports event or adjust conditions within the environment based on a real-time crowd or weather data. As a specific example, in a theme park simulation, a virtual park would remain static even when a corresponding physical park experiences a surge in visitors, preventing the virtual park experience from mirroring real-world crowd levels, operational changes, new attractions, and/or the like.

As the foregoing illustrates, what is needed in the art are more effective techniques for generating virtual environments.

### SUMMARY

One embodiment of the present disclosure sets forth a computer-implemented method for generating a virtual environment. The method includes receiving one or more real-time feeds and one or more user inputs. The method further includes generating, using a first trained machine learning model and based on the one or more real-time feeds and the user input, a description of a virtual environment state. In addition, the method includes generating, based on the description of the virtual environment state, the virtual environment. Furthermore, the method includes outputting the virtual environment via at least one output device.

At least one technical advantage of the disclosed techniques relative to the prior art is that the disclosed techniques permit virtual environments to dynamically respond to real-time physical events. Unlike conventional approaches where the virtual environment remains static with respect to physical events once manually programmed or generated by a machine learning model, the disclosed techniques utilize an ensemble of agents as well as a fine-tuned language model to continuously update the virtual environment based on real-time feeds of physical events and optionally human-in-the-loop inputs. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2A is a more detailed illustration of the machine learning server of FIG. 1, according to various embodiments;

FIG. 2B is a more detailed illustration of the computing device of FIG. 1, according to various embodiments;

FIG. 3 is a more detailed illustration of the model trainer of FIG. 1, according to various embodiments;

FIG. 4 is a more detailed illustration of the virtual environment generator of FIG. 1, according to various embodiments;

FIG. 5 is a flow diagram of method steps for training and fine-tuning a language model, according to various embodiments; and

FIG. 6 is a flow diagram of method steps for generating a virtual environment, according to various embodiments.

### DETAILED DESCRIPTION

In the following description, numerous specific details are set forth to provide a more thorough understanding of the various embodiments. However, it will be apparent to one of skill in the art that the inventive concepts can be practiced without one or more of these specific details.

### System Overview

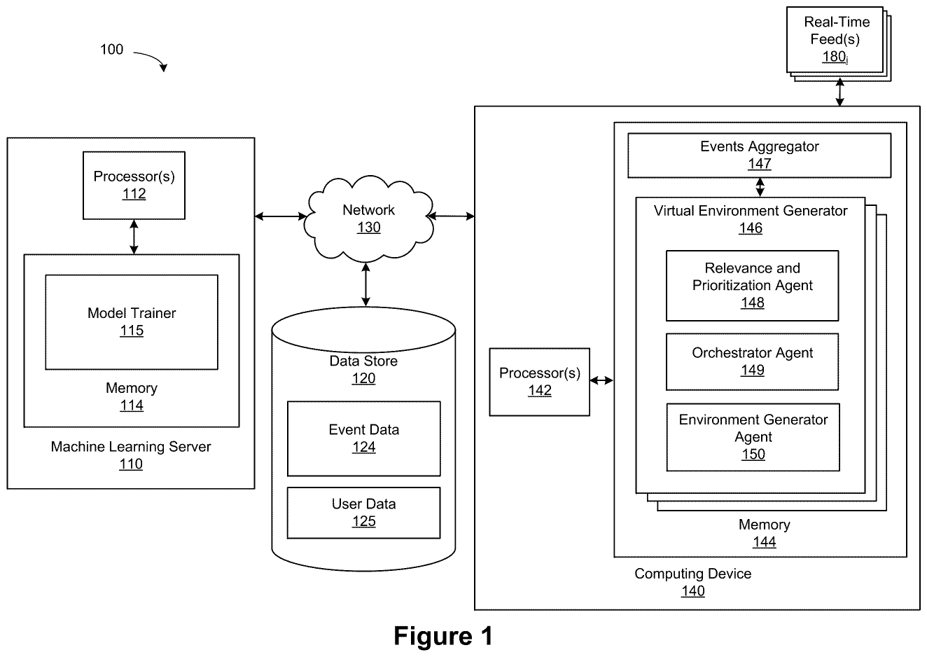

FIG. 1 illustrates a block diagram of a computer-based system 100 configured to implement one or more aspects of at least one embodiment. As shown, system 100 includes, without limitation, a machine learning server 110, a data store 120, and a computing device 140 in communication over a network 130, which can include a wide area network (WAN) such as the Internet, a local area network (LAN), a cellular network, and/or any other suitable network or networks.

As shown, a model trainer 115 executes on one or more processors 112 of machine learning server 110 and is stored in a memory 114 of machine learning server 110. Processor(s) 112 receive user input from input devices, such as a keyboard, a mouse, a trackpad, a touch screen, or a microphone. In operation, processor(s) 112 may include one or more primary processors of machine learning server 110, controlling and coordinating operations of other system components. In particular, processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

Memory 114 of machine learning server 110 stores content, such as software applications and data, for use by processor(s) 112 and the GPU(s) and/or other processing units. Memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace memory 114. The storage can include any number and type of external memories that are accessible to processor(s) 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

Machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in memory 114 can be modified as desired. Further, the connection topology between the various units in FIG. 1 can be modified as desired. In some embodiments, any combination of processor(s) 112, memory 114, and/or GPU(s) can be included in and/or replaced with any type of virtual computing system, distributed computing system, and/or cloud computing environment, such as a public, private, or a hybrid cloud system.

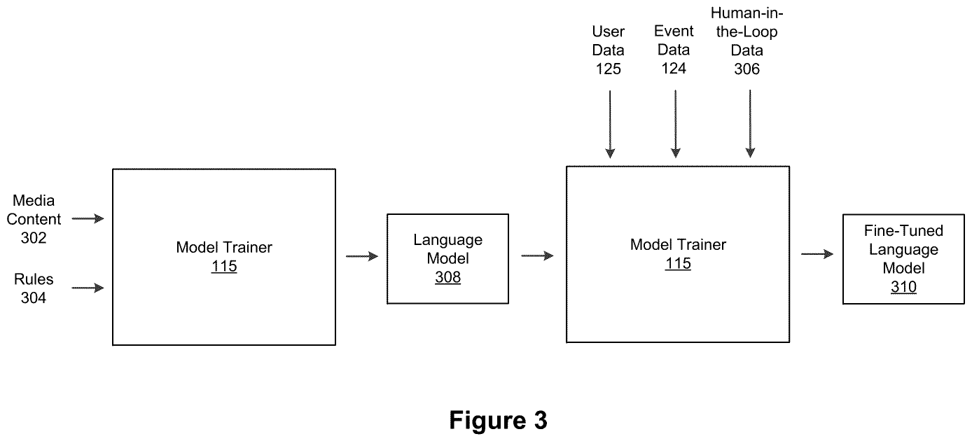

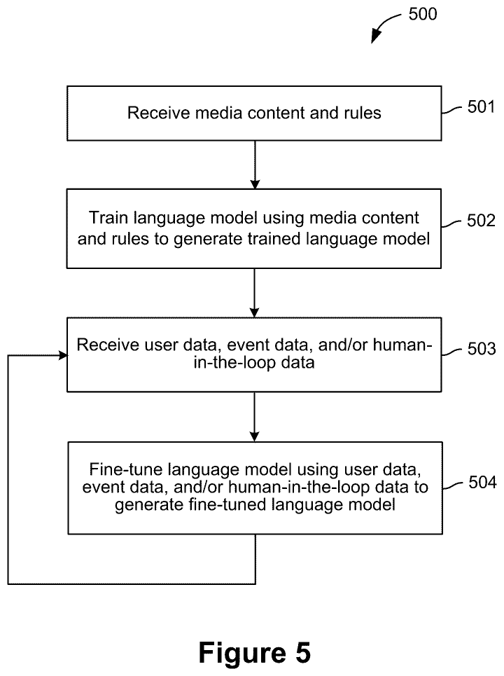

In some embodiments, model trainer 115 is configured to train and/or fine-tune one or more machine learning models, including a language model included in an orchestrator agent 149. Techniques for training the language model using media content and rules and fine-tuning the language model using event data 124, user data 125, and/or human-in-the loop data received from one or more I/O devices (not shown) are discussed in greater detail below in conjunction with FIGS. 3 and 5. Training data, including event data 124 and user data 125, can be stored in data store 120, or elsewhere. In some embodiments, data store 120 can include any storage device or devices, such as fixed disc drive(s), flash drive(s), optical storage, network attached storage (NAS), and/or a storage area-network (SAN). Although shown as accessible over network 130, in at least one embodiment machine learning server 110 can include data store 120.

As shown, an events aggregator 147 and a virtual environment generator 146 are stored in memory 144 and execute on processor(s) 142, of computing device 140. In some embodiments, memory 144 and processor(s) 142 can be similar to memory 114 and processor(s) 112, respectively, of machine learning server 110, described above. Events aggregator 147 is an application that aggregates one or more real-time feed(s) 180ᵢ (referred to herein collectively as real-time feeds 180 and individually as a real-time feed 180) and generates aggregated events. In some embodiments, real-time feeds 180 include continuously updated and/or application programming interface (API) driven streams of external data originating from physical-world events. For example, real-time feeds 180 could include live sports statistics (e.g., goals scored, player performance metrics, match outcomes, player movements, and/or the like), theme park telemetry (e.g., crowd density, queue wait times, ride availability, and/or the like), weather conditions (e.g., temperature, precipitation, storm alerts, traffic data, and/or the like), social media trends, financial markets, or sensor outputs from connected physical environments.

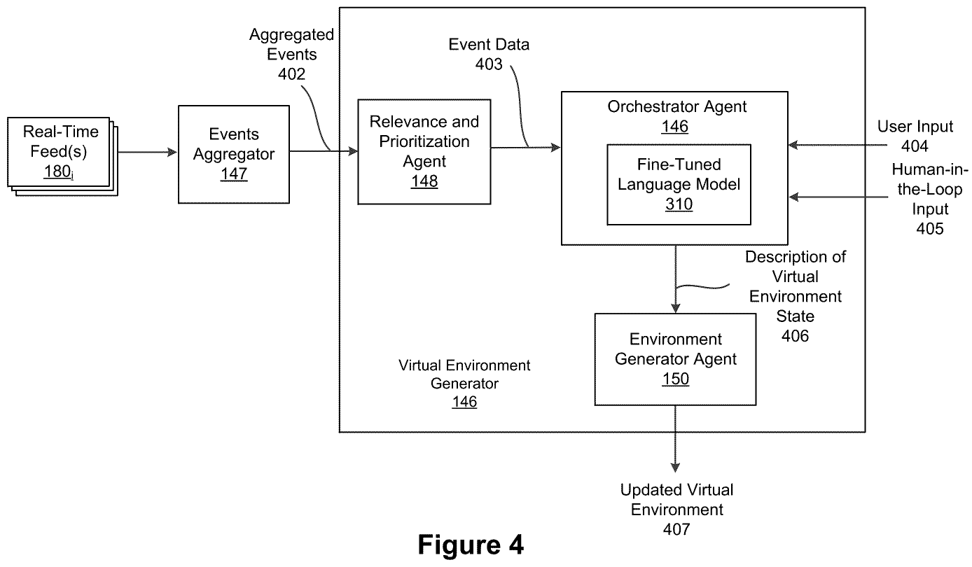

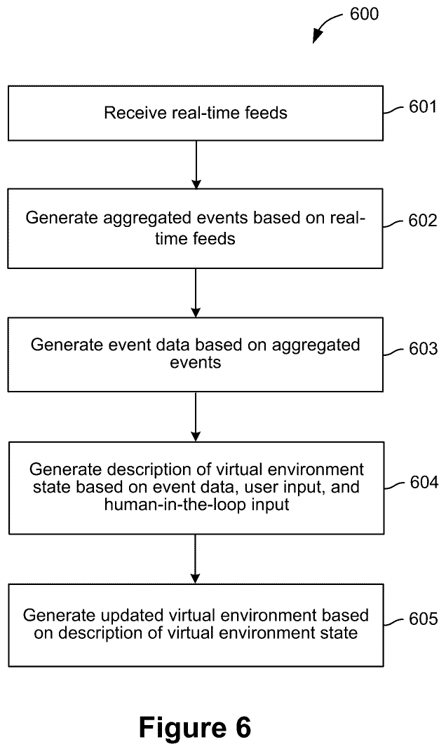

Virtual environment generator 146 is an application that processes the aggregated events as well as user input and human-in-the-loop input received from one or more I/O devices (not shown) and generates a virtual environment. As shown, virtual environment generator 146 includes an ensemble of agents, including but not limited to, a relevance and prioritization agent 148, an orchestrator agent 149, and an environment generator agent 150. As used herein, an “agent” is an artificial intelligence (AI) system configured to autonomously perform one or more actions to accomplish one or more tasks. Virtual environment generator 146 is described in greater detail below in conjunction with FIGS. 4 and 6.

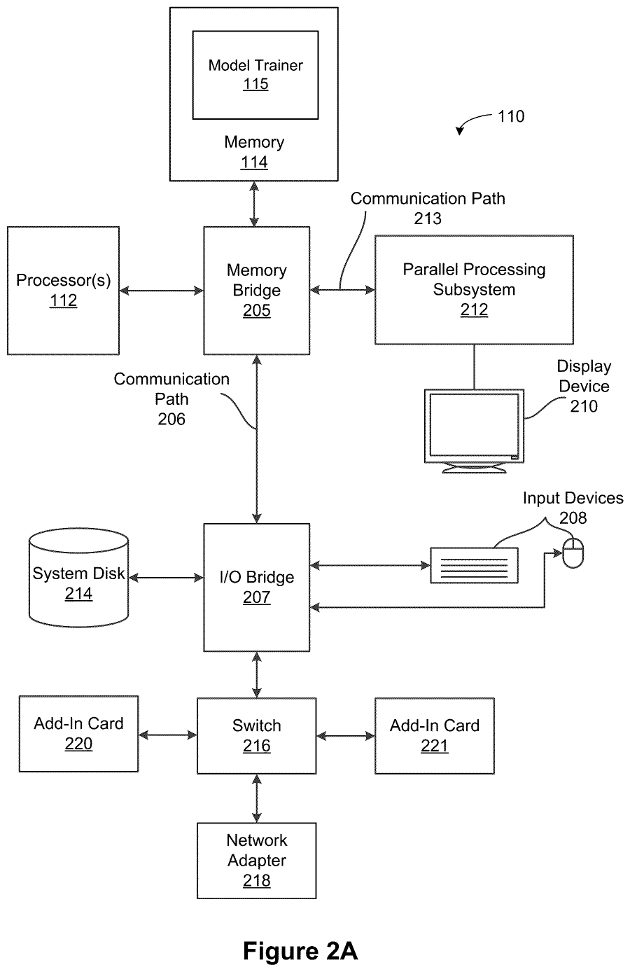

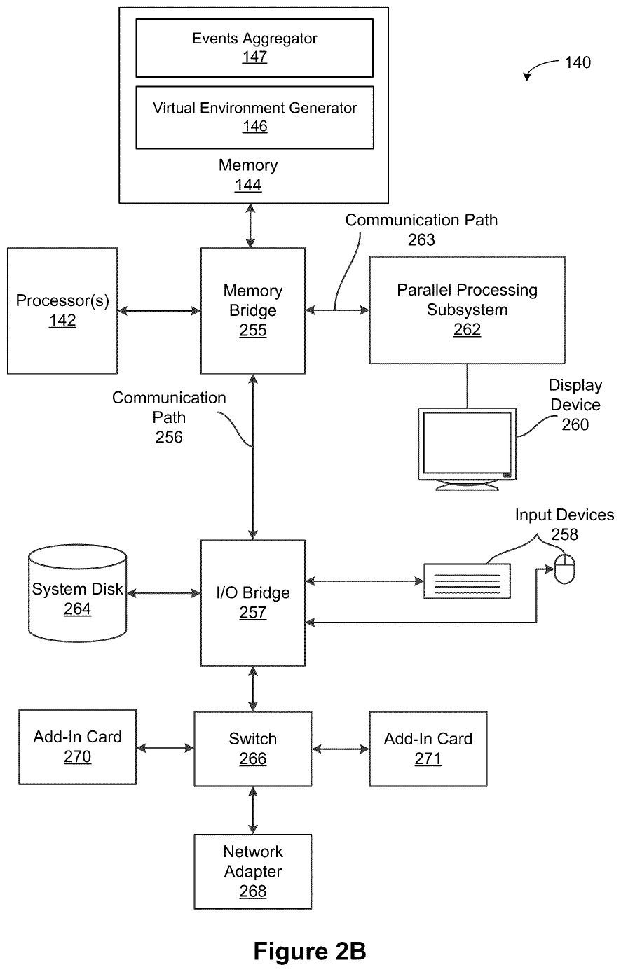

FIG. 2A is a more detailed illustration of machine learning server 110 of FIG. 1, according to various embodiments. Machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, machine learning server 110 is a server machine operating in a data center or a cloud computing environment that provides scalable computing resources as a service over a network.

In various embodiments, machine learning server 110 includes, without limitation, processor(s) 112 and memory 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In some embodiments, I/O bridge 207 is configured to receive user input information from optional input devices 208, such as a keyboard, mouse, touch screen, sensors (e.g., camera, microphone, etc.), and/or the like, and forward the input information to processor(s) 112 for processing. In some embodiments, machine learning server 110 may be a server machine in a cloud computing environment. In such embodiments, machine learning server 110 may not include input devices 208, but may receive equivalent input information by receiving commands (e.g., responsive to one or more inputs from a remote computing device) in the form of messages transmitted over a network and received via network adapter 218. In some embodiments, switch 216 is configured to provide connections between I/O bridge 207 and other components of machine learning server 110, such as a network adapter 218 and various add-in cards 220 and 221.

In some embodiments, I/O bridge 207 is coupled to a system disk 214 that may be configured to store content and applications and data for use by processor(s) 112 and parallel processing subsystem 212. In some embodiments, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid-state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, parallel processing subsystem 212 may incorporate circuitry optimized for graphics and video processing, including, for example, video output circuitry. Such circuitry may be incorporated across one or more parallel processing units (PPUs), also referred to herein as parallel processors, included within parallel processing subsystem 212.

In some embodiments, parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. Memory 114 includes at least one device driver configured to manage the processing operations of the one or more PPUs within parallel processing subsystem 212. In addition, memory 114 includes model trainer 115. Although described herein primarily with respect to model trainer 115, techniques disclosed herein can also be implemented, either entirely or in part, in other software and/or hardware, such as in parallel processing subsystem 212.

In various embodiments, parallel processing subsystem 212 may be integrated with one or more of the other elements of FIG. 2A to form a single system. For example, parallel processing subsystem 212 may be integrated with processor(s) 112 and other connection circuitry on a single chip to form a system on a chip (SoC).

In some embodiments, processor(s) 112 includes the primary processor of machine learning server 110, controlling and coordinating operations of other system components. In some embodiments, processor(s) 112 issue commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, may be modified as desired. For example, in some embodiments, memory 114 could be connected to processor(s) 112 directly rather than through memory bridge 205, and other devices may communicate with memory 114 via memory bridge 205 and processor(s) 112. In other embodiments, parallel processing subsystem 212 may be connected to I/O bridge 207 or directly to processor(s) 112, rather than to memory bridge 205. In still other embodiments, I/O bridge 207 and memory bridge 205 may be integrated into a single chip instead of existing as one or more discrete devices. In certain embodiments, one or more components shown in FIG. 2A may not be present. For example, switch 216 could be eliminated, and network adapter 218 and add-in cards 220, 221 would connect directly to I/O bridge 207. Lastly, in certain embodiments, one or more components shown in FIG. 2A may be implemented as virtualized resources in a virtual computing environment, such as a cloud computing environment. For example, parallel processing subsystem 212 may be implemented as a virtualized parallel processing subsystem in at least one embodiment. As a specific example, parallel processing subsystem 212 may be implemented as virtual graphics processing unit(s) (vGPU(s)) that render graphics on a virtual machine(s) (VM(s)) executing on server machine(s) whose GPU(s) and other physical resources are shared across one or more VMs.

FIG. 2B is a more detailed illustration of computing device 140 of FIG. 1, according to various embodiments. Computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, computing device 140 is a server machine operating in a data center or a cloud computing environment that provides scalable computing resources as a service over a network.

In various embodiments, computing device 140 includes, without limitation, processor(s) 142 and memory 144 coupled to a parallel processing subsystem 212 via a memory bridge 255 and a communication path 263. Memory bridge 255 is further coupled to an I/O bridge 257 via a communication path 256, and I/O bridge 257 is, in turn, coupled to a switch 266.

In some embodiments, I/O bridge 257 is configured to receive user input information from optional input devices 258, such as a keyboard, mouse, touch screen, sensors (e.g., camera, microphone, etc.), and/or the like, and forward the input information to processor(s) 142 for processing. In some embodiments, computing device 140 may be a server machine in a cloud computing environment. In such embodiments, computing device 140 may not include input devices 258, but may receive equivalent input information by receiving commands (e.g., responsive to one or more inputs from a remote computing device) in the form of messages transmitted over a network and received via network adapter 268. In some embodiments, switch 266 is configured to provide connections between I/O bridge 257 and other components of computing device 140, such as a network adapter 268 and various add-in cards 270 and 271.

In some embodiments, I/O bridge 257 is coupled to a system disk 264 that may be configured to store content and applications and data for use by processor(s) 142 and parallel processing subsystem 262. In some embodiments, system disk 264 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid-state storage devices. In various embodiments, other components, such as universal serial bus or other port connections, compact disc drives, digital versatile disc drives, film recording devices, and the like, may be connected to I/O bridge 257 as well.

In various embodiments, memory bridge 255 may be a Northbridge chip, and I/O bridge 257 may be a Southbridge chip. In addition, communication paths 256 and 263, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 262 comprises a graphics subsystem that delivers pixels to an optional display device 260 that may be any conventional cathode ray tube, liquid crystal display, light-emitting diode display, and/or the like. In such embodiments, parallel processing subsystem 262 may incorporate circuitry optimized for graphics and video processing, including, for example, video output circuitry. Such circuitry may be incorporated across one or more PPUs, also referred to herein as parallel processors, included within parallel processing subsystem 262.

In some embodiments, parallel processing subsystem 262 incorporates circuitry optimized (e.g., that undergoes optimization) for general purpose and/or compute processing. Again, such circuitry may be incorporated across one or more PPUs included within parallel processing subsystem 262 that are configured to perform such general purpose and/or compute operations. In yet other embodiments, the one or more PPUs included within parallel processing subsystem 262 may be configured to perform graphics processing, general purpose processing, and/or compute processing operations. Memory 144 includes at least one device driver configured to manage the processing operations of the one or more PPUs within parallel processing subsystem 262. In addition, memory 144 includes events aggregator 147 and virtual environment generator 146. Although described herein primarily with respect to events aggregator 147 and virtual environment generator 146, techniques disclosed herein can also be implemented, either entirely or in part, in other software and/or hardware, such as in parallel processing subsystem 262.

In various embodiments, parallel processing subsystem 262 may be integrated with one or more of the other elements of FIG. 2B to form a single system. For example, parallel processing subsystem 262 may be integrated with processor(s) 142 and other connection circuitry on a single chip to form a SoC.

In some embodiments, processor(s) 142 includes the primary processor of computing device 140, controlling and coordinating operations of other system components. In some embodiments, processor(s) 142 issue commands that control the operation of PPUs. In some embodiments, communication path 263 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 262, may be modified as desired. For example, in some embodiments, memory 144 could be connected to processor(s) 142 directly rather than through memory bridge 255, and other devices may communicate with memory 144 via memory bridge 255 and processor(s) 142. In other embodiments, parallel processing subsystem 262 may be connected to I/O bridge 257 or directly to processor(s) 142, rather than to memory bridge 255. In still other embodiments, I/O bridge 257 and memory bridge 255 may be integrated into a single chip instead of existing as one or more discrete devices. In certain embodiments, one or more components shown in FIG. 2B may not be present. For example, switch 266 could be eliminated, and network adapter 268 and add-in cards 270, 271 would connect directly to I/O bridge 257. Lastly, in certain embodiments, one or more components shown in FIG. 2B may be implemented as virtualized resources in a virtual computing environment, such as a cloud computing environment. For example, parallel processing subsystem 262 may be implemented as a virtualized parallel processing subsystem in at least one embodiment. As a specific example, parallel processing subsystem 262 may be implemented as virtual graphics processing unit(s) (vGPU(s)) that render graphics on a virtual machine(s) (VM(s)) executing on server machine(s) whose GPU(s) and other physical resources are shared across one or more VMs.

### Fine-Tuning a Language Model to Generate Descriptions of Virtual Environment States

FIG. 3 is a more detailed illustration of model trainer 115 of FIG. 1, according to various embodiments. As shown, model trainer 115 uses media content 302 and a set of rules 304 to train language model 308. After language model 308 is trained, model trainer 115 can re-train (i.e., fine tune) language model 308 using user data 125, event data 124, and human-in-the-loop data 306 to generate fine-tuned language model 310.

Each of language model 308 and fine-tuned language model 310 is a machine learning model, such as a neural network, which processes one or more inputs, such as event data, user input, user data, human-in-the-loop input, a prior virtual environment state, and/or and rules 304, to generate a description of a virtual environment state. In some embodiments, language model 308 and fine-tuned language model 310 are trained to process input text and generate text outputs. For example, each of language model 308 and fine-tuned language model 310 can be a large language model (LLM) in some embodiments. In some embodiments, each of language model 308 and fine-tuned language model 310 can be a multi-modal model that is capable of processing text as well as other types of inputs, such as image, video, and/or audio inputs. Media content 302 can include stories, screenplays (e.g., scripts), dialogue transcripts, video descriptions, audio tracks, closed captioning, gameplay footage as well as gameplay updates and statistics, news reports (e.g., articles), theme park maps and attraction information, live video, and/or the like. In some embodiments, rules 304 include design rules, such as narrative constraints, stylistic guidelines, environment logic parameters, structural templates, storylines, and/or the like, that guide the generation of coherent and contextually appropriate content within a virtual environment. In some embodiments, rules 304 include technical rules that define how language model 308 operates and/or interacts with environment generator agent 150, including but not limited to how prompts are structured, physics and/or in-game mechanics (e.g., how buildings or other structures can be built and look during different stages of being built) that language model 308 should implement, how outputs are formatted, and/or how environment generation components are invoked. In some embodiments, design rules are mutable rather than static. In some embodiments, design rules translate information, either one-to-one from live events to the virtual environment, or translated to one or more in-game parameters in a manner that is not one-to-one. In some examples, rules 304 could define relationships between characters, acceptable plot progressions, environmental behaviors, genre-specific tones (e.g., fantasy, sci-fi, historical), and/or the permissible boundaries for altering or expanding the virtual environment. In some embodiments, language model 308 includes a large language model to generate text-based descriptions, such as dialogue, character descriptions, branching storylines, and/or the like. In some embodiments, language model 308 includes a vision-language model to generate or understand multimodal content, such as aligning character actions with visual scenes or generating scene descriptions from input images or video. In some embodiments, a description of the virtual environment state includes a structured representation of conditions, elements, and relationships present in the virtual environment at a given moment in time. For example, the description could include character status and interactions (e.g., “The queen is preparing for battle in the northern kingdom”), environmental conditions (e.g., “A thunderstorm is approaching the eastern region”), evolving plot points (e.g., “The alliance between the mountain tribes has been broken”), spatial configurations (e.g., “The castle gate is now open and accessible to players”), game levels and/or modes (e.g., “Game level X has been unlocked”), and/or the like. In some embodiments, language model 308 generates the description of virtual environment state in various formats, such as natural language, structured data (e.g., JavaScript Object Notation (JSON) or scene graphs), or a hybrid format. In some embodiments, language model 308 is pre-trained using a large corpus of general-purpose text and/or multimodal data, such as books, articles, websites, video captions, and other publicly available datasets.

In some embodiments, model trainer 115 performs one or more training operations, such as supervised learning, unsupervised learning, and/or reinforcement learning using media content 302 and rules 304 to train a language model, generating trained language model 308. For example, model trainer 115 could use supervised learning and rules 304 that provide pairs of event inputs and example descriptions of virtual environment states to train language model to output descriptions of virtual environment states for various types of events. Any technically feasible training technique(s), such as backpropagation with gradient descent to minimize a next-token prediction loss, or a variation thereof, can be used in some embodiments. As another example, model trainer 115 could perform supervised learning using labeled pairs of media content 302 and descriptions of virtual environment states to train language model 308. Model trainer 115 can also perform unsupervised learning based on rules 304 and/or media content 302 to capture stylistic and structural patterns of a story. In some embodiments, model trainer 115 uses reinforcement learning to optimize language model 308 for specific objectives, such as maintaining narrative consistency, enhancing engagement, or aligning with predefined rules 304. Once language model 308 is trained, model trainer 115 stores language model 308 in memory 144 or elsewhere, and the stored language model 308 can be deployed for use in any suitable application, including virtual environment generator 146.

In some embodiments, model trainer 115 receives additional training data, including user data 125, event data 124, and human-in-the-loop data 306, and performs one or more re-training operations to generate a fine-tuned language model 310. User data 125 includes engagement signals, user behavior, sentiment information, and/or the like, collected from users interacting with the virtual environment. Event data 124 is data associated with one or more physical events in the real world. In some embodiments, event data 124 includes structured representations of real-world events, such as crowd activity, live theme park events, time-stamped occurrences within a physical location, and/or the like. Human-in-the-loop data 306 is data associated with one or more human operator inputs. In some embodiments, human-in-the-loop data 306 includes a collection of human operator inputs such as direct modifications, creative inputs, curated decisions, and/or the like, made by human operators during the generation of virtual environment(s). For example, a human operator could specify how a virtual environment should respond to a particular real-world event. In some embodiments, model trainer 115 re-trains language model 308 to adjust the parameters of language model 308 to improve the ability of language model 308 to generate descriptions of virtual environment states that are more aligned with actual user preferences included in user data 125, real-world developments included in event data 124, and/or human-in-the loop data 306, thereby creating fine-tuned language model 310. Any technically feasible training technique(s), such as backpropagation with gradient descent to minimize a next-token prediction loss, or a variation thereof, can be used in some embodiments.

In addition or alternative to training/re-training language model 308, in some embodiments, zero-shot learning and/or few-shot learning can be employed, where language model 308 generates output descriptions based on structured prompts and/or rules instead of direct training examples. For example, language model 308 could be prompted with a prompt that includes rules/instructions to generate a description of a game environment that is set in a particular location and has a particular theme or belongs to a particular story. In some embodiments, the prompts can also be based on human-in-the-loop data 306, such as instructions or adjustments made by a person to control how language model 308 generates descriptions of virtual environment states. In some embodiments, prompt engineering can also be employed, where prompts are written or adjusted to guide language model 308 toward generating descriptions of virtual environment states that match the desired tone, style, and/or content for the virtual environment.

### Virtual Environment Generation Based On Real-Time Feeds, User Input, and Human-In-The-Loop Input

FIG. 4 is a more detailed illustration of virtual environment generator 146 of FIG. 1, according to various embodiments. As shown, events aggregator 147 aggregates real-time feeds 180 and generates aggregated events 402. Virtual environment generator 146 processes aggregated events 402, user input 404, and human-in-the-loop input 405 and generates updated virtual environment 407. Virtual environment generator 146 includes, without limitation, relevance and prioritization agent 148, orchestrator agent 149, and environment generator agent 150. Relevance and prioritization agent 148 processes aggregated events 402 and generates event data 403. Orchestrator agent 149 includes, without limitation, fine-tuned language model 310. Although described herein primarily with respect to fine-tuned language model 310 for illustrative purposes, it should be understood that language model 308 can be used instead before fine-tuned language model 310 is trained. Orchestrator agent 149 uses fine-tuned language model 310 to process event data 403, user input 404, and human-in-the-loop input 405 and generate a description of a virtual environment state 406. Environment generator agent 150 processes description of virtual environment state 406 and generates updated virtual environment 407.

Events aggregator 147 is an application that aggregates real-time feeds 180 and generates aggregated events 402. In some embodiments, aggregated events 402 represent specific happenings or conditions of interest (i.e., events), such as “parade starting in park zone A,” “character spotted near attraction B,” “player X scored a goal in a live match,” etc. In some embodiments, events aggregator 147 routes different subsets of aggregated events 402 to one or more virtual environment instances, each of which correspond, for example, to a separate game, simulation, or interactive narrative experience. In some embodiments, real-time feeds 180 are received via one or more I/O devices, an Application Programming Interface (API), and/or the like. In some embodiments, real-time feeds 180 can originate from external systems, such as a theme park infrastructure, event scheduling systems, sensors, third-party data providers, or live content streams. In some embodiments, real-time feeds 180 can be transmitted over a network connection, such as network 130, and received by computing device 140 in any suitable format, such as JSON, Extensible Markup Language (XML), streaming protocols, proprietary data formats, and/or the like.

Virtual environment generator 146 is an application that processes aggregated events 402, user input 404, and human-in-the-loop input 405 and generates updated virtual environment 407. Any suitable updated virtual environment 407 can be generated in some embodiments, such as a game environment, a virtual or augmented reality environment, and/or the like. User input 404 includes interactions from users or participants within the virtual environment. For example, user input 404 could include navigation commands, dialogue selections, object interactions, gameplay decisions, and/or the like. A user can choose to follow a character, interact with a virtual kiosk, select from a menu of quests, and/or the like, all of which can influence how the virtual environment responds or evolves. Human-in-the-loop input 405 includes human operator input such as direct instructions or overrides provided by a human operator, such as a content creator, game designer, live event director, and/or the like. In some embodiments, user input 404 are received through in-game actions, user interface (UI) selections, motion tracking, voice commands, device interactions, and/or the like. Human-in-the-loop input 405 allows human operators to control or influence the virtual environment in real time or semi-automated workflows. For example, a human operator observing in aggregated events 402 that character A has entered a physical house in a theme park can instruct virtual environment generator 146 to generate a specific scene, such as “Character A is inside the house singing,” rather than allowing virtual environment generator 146 to generate other content autonomously. In another example, when virtual environment generator 146 is about to automatically generate a scene or behavior that could be inappropriate or unsuitable for the environment or a group or audience, such as a character performing an action that conflicts with brand guidelines or expected behavior, the human operator could intervene to either modify the generated output to a suitable alternative or block the output. In some embodiments, human-in-the-loop input 405 are received through an authoring interface, control dashboard, scripting console, and/or the like. Updated virtual environment 407 includes the current state of the virtual environment after being modified based on the latest aggregated events 402, user input 404, and human-in-the-loop input 405. In various embodiments, the updates include changes to characters, environments, narrative progression, interactive elements, and/or the like. For example, if an aggregated event 402 indicates that a live parade has started in a physical theme park, the virtual environment generator 146 can respond by generating updated virtual environment 407 in which characters, decorations, or music are spawned in a corresponding virtual plaza. More generally, event data included in aggregated events 402 can cause changes in the environment that are one-to-one (e.g., a point scored in a physical sports game causes a value to increase by one within a game) or not one-to-one (e.g., a point scored in a physical sports game causes multiple different values to change, enables various new options, and/or the like within a game). In some embodiments, virtual environment generator 146 performs end-to-end processing of aggregated events 402, user input 404, and human-in-the-loop input 405 to generate updated virtual environment 407, permitting aggregated real-world data and user interactions to be translated directly into real-time updates in the virtual environment.

Relevance and prioritization agent 148 is an AI agent which processes aggregated events 402 and generates event data 403. In some embodiments, relevance and prioritization agent 148 evaluates aggregated events 402 based on predefined rules, author-defined importance levels, contextual filters, and/or trained machine learning models to determine which events are most significant or actionable for a given virtual environment. In some embodiments, relevance and prioritization agent 148 can include any technically feasible machine learning model, such as a learned ranking model, a language model, a multimodal model, a reasoning model, and/or the like. For example, if multiple events are received, such as “a character has entered a ride,” “a fireworks show has started,” and “a ride queue exceeds 45 minutes”, relevance and prioritization agent 148 can assign higher priority to the fireworks show for visual synchronization in a virtual theme park environment, while deprioritizing the ride queue data. In some embodiments, relevance and prioritization agent 148 applies temporal filtering, location-based constraints, or thematic matching to permit that relevant and timely information is forwarded for use. Event data 403 includes the filtered and prioritized subset of aggregated events 402 that are deemed most relevant to the virtual environment generator 146. For example, event data 403 can include structured descriptions of selected events, context (e.g., time, location, category), and any metadata used for the orchestration of the virtual environment. In some embodiments, relevance and prioritization agent 148 is specific to a particular virtual environment generator application. In some other embodiments, relevance and prioritization agent 148 can be used across multiple different virtual environment generator applications.

Orchestrator agent 149 is an AI agent that processes event data 403, user input 404, and human-in-the-loop input 405 and generates a description of virtual environment state 406. Although event data 403, user input 404, and human-in-the-loop input 405 are shown as being input into orchestrator agent 149 as a reference example, in some embodiments, orchestrator agent 149 can also receive any other suitable inputs, such as a current virtual environment state. Orchestrator agent 149 includes, without limitation, fine-tuned language model 310. As described, fine-tuned language model 310 is a machine learning model, such as a neural network, that is trained to process input text and generate text outputs. For example, in some embodiments, fine-tuned language model 310 can be a large language model (LLM) or a multi-modal model. In some embodiments, fine-tuned language model 310 can be trained and/or prompted to generate descriptions of virtual environment states, as described above in conjunction with FIG. 4. In such cases, orchestrator agent 149 uses fine-tuned language model 310 to generate a description of virtual environment state 406 based on event data 403, user input 404, and human-in-the-loop input 405 and formats the inputs into a consistent output, namely description of virtual environment state 406, that reflects what has to be displayed and/or updated in the virtual environment. In some embodiments, orchestrator agent 149 can be configured to generate virtual environment states for any suitable game, such as anything from scripted but dynamically generated and interactive story worlds to open-world game environments that offer users greater freedom in exploring and engaging with the game world. In some embodiments, orchestrator agent 149 handles the scripting and narrative of a game, such as guiding the game along a pre-scripted storyline. In some embodiments, fine-tuned language model 310 receives as input a combination of event data 403 (e.g., “parade started in area A”), user input 404 (e.g., “user entered zone B”), and human-in-the-loop input 405 (e.g., “add a character interaction”) along with any relevant prior virtual environment state information. Orchestrator agent 149 uses fine-tuned language model 310 to process event data 403, user input 404, and human-in-the-loop input 405 using a prompt or template that defines the format and scope of the output description of virtual environment state 406. For example, the prompt can ask fine-tuned language model 310 to describe the current scene, characters, and actions included in the virtual environment based on the inputs. Fine-tuned language model 310 could then output description of virtual environment state 406, such as: “A parade is moving through the central plaza. Confetti is falling. Character A is waving to the crowd near the fountain.”

Environment generator agent 150 is an AI agent that processes description of virtual environment state 406 and generates an updated virtual environment 407. Although description of virtual environment state 406 is shown as input into environment generator agent 150 as a reference example, in some embodiments, environment generator agent 150 can take as input any suitable data in addition to description of virtual environment state 406, such as user input 404, a previous virtual environment state, etc. In some embodiments, environment generator agent 150 parses description of virtual environment state 406 to identify which elements need to be added, removed, modified, or animated. For example, environment generator agent 150 could determine which assets to load, what actions occur, where to place the assets in a scene, what animations or effects to trigger, and how to update interactions between characters or objects. In some embodiments, environment generator agent 150 uses a generative AI model, game engine, rendering engine, content scripting system, and/or the like to apply the changes and generate updated virtual environment 407. For example, in some embodiments, the generative AI model can be an open world model that generates a next video frame conditioned on inputs provided by the environment generator agent 150, such as a current video frame, assets to place within the virtual environment, and user input. In such cases, the open world model can have any technically feasible architecture (e.g., a transformer-based architecture) and be trained using any suitable data. For example, the open world model and/or one or more adapters (e.g., low-rank adapters (LoRA)) that are added to the open world model could be trained and/or fine-tuned to permit conditioning of generated inputs on text descriptions of virtual environment states that are output by orchestrator agent 149, and the open world model and/or adapter(s) could be further trained using example images, film footage, and/or the like to generate desired virtual environments and/or assets therein (e.g., themed worlds, specific characters, artistic styles, etc.). Further, the generative AI model can be invoked to update the virtual environment at any suitable frequency, such as every frame, every second, or the like. As another example, in some embodiments, the generative AI model can be used to create or enhance assets, such as textures, animations, background elements, or filler characters based on the description of the virtual environment state 406. In such cases, the assets can be placed within the virtual environment using a game engine, the generative AI model itself, and/or the like, and the assets could also be controlled within the virtual environment by environment generator agent 150. As a specific example, if the description states that “a parade is moving through the central plaza,” the environment generator could use the generative AI model to create and/or place parade floats, spawn characters, add sound effects, and animate movement within the virtual environment. As another example, if the description includes “Character A is inside the house singing,” environment generator agent 150 could load the interior of the house within a game engine, place the character A model in the correct position, and trigger a singing animation along with background audio.

In some embodiments, virtual environment generator 146 can also include one or more moderation agents and/or models (not shown) that check the outputs of relevance and prioritization agent 148, orchestrator agent 149, and/or environment generator agent 150 using rules or policies to ensure that desired outputs are being generated. For example, if relevance and prioritization agent 148 outputs negative events that should not be used to update a virtual environment, then the moderation agent(s) and/or model(s) could modify or otherwise prevent the negative events from being processed by orchestrator agent 149. As another example, if orchestrator agent 149 outputs a negative description of a virtual environment state that should not be generated, then the moderation agent(s) and/or model(s) could modify the description of the virtual environment state 406.

Once generated, the updated virtual environment 407 can be output to one or more users using any technically feasible output device(s). For example, if the environment generator agent 150 generates video frames of the updated virtual environment 407, the video frames could be output via a display device and associated audio could be output via a speaker device. As another example, if the environment generator agent 150 generates the updated virtual environment 407 as an extended reality (XR) environment, such as an augmented reality (AR), virtual reality (VR), or mixed reality (MR) environment, the XR environment could be output via an XR headset.

FIG. 5 is a flow diagram of method steps for training and fine-tuning a language model, according to various embodiments. Although the method steps are described in conjunction with the systems of FIGS. 1-4, persons skilled in the art will understand that any system configured to perform the method steps in any order falls within the scope of the present embodiments.

As shown, a method 500 begins with step 501, where model trainer 115 receives media content 302 and rules 304. Media content 302 can include stories, dialogue transcripts, video descriptions, gameplay footage, theme park maps and attraction information, and/or the like. In some embodiments, rules 304 include design rules, such as narrative constraints, stylistic guidelines, environment logic parameters, structural templates, storylines, and/or the like, that guide the generation of coherent and contextually appropriate content within a virtual environment. In some embodiments, rules 304 include technical rules that define how language model 308 operates and/or interacts with environment generator agent 150, including but not limited to how prompts are structured, physics and/or in-game mechanics that language model 308 should implement, how outputs are formatted, and/or how environment generation components are invoked. In some embodiments, design rules are mutable rather than static. In some embodiments, design rules translate information, either one-to-one from live events to the virtual environment, or translated to one or more in-game parameters in a manner that is not one-to-one. In some examples, rules 304 could define relationships between characters, acceptable plot progressions, environmental behaviors, genre-specific tones, and/or the permissible boundaries for altering or expanding the virtual environment.

At step 502, model trainer 115 trains a language model using media content 302 and rules 304 to generate trained language model 308. In some embodiments, model trainer 115 performs one or more training operations, such as supervised learning, unsupervised learning, and/or reinforcement learning using media content 302 and rules 304 to train language model 308, generating trained language model 308. For example, model trainer 115 could use supervised learning and rules 304 that provide pairs of event inputs and example descriptions of virtual environment states to train language model 308 to output descriptions of virtual environment states for various types of events. Any technically feasible training technique(s), such as backpropagation with gradient descent to minimize a next-token prediction loss, or a variation thereof, can be used in some embodiments. As another example, model trainer 115 could perform supervised learning using labeled pairs of media content 302 and descriptions of virtual environment states to train language model 308. Model trainer 115 can also perform unsupervised learning based on rules 304 and/or media content 302 to capture stylistic and structural patterns of a story. In some embodiments, model trainer 115 uses reinforcement learning to optimize language model 308 for specific objectives, such as maintaining narrative consistency, enhancing engagement, or aligning with predefined rules 304. Once language model 308 is trained, model trainer 115 stores language model 308 in memory 144 or elsewhere, and the stored language model 308 can be deployed for use in any suitable application, including virtual environment generator 146.

At step 503, model trainer 115 receives user data 125, event data 124, and/or human-in-the-loop data 306. User data 125 includes engagement signals, user behavior, sentiment information, and/or the like, collected from users interacting with the virtual environment. In some embodiments, event data 124 includes structured representations of real-world events, such as crowd activity, live theme park events, time-stamped occurrences within a physical location, and/or the like. In some embodiments, human-in-the-loop data 306 includes human operator inputs such as direct modifications, creative inputs, curated decisions, and/or the like, made by human operators during the generation of virtual environment(s). For example, a human operator could specify how a virtual environment should respond to a particular real-world event.

At step 504, model trainer 115 fine-tunes language model 308 using user data 125, event data 124, and/or human-in-the-loop data 306 to generate fine-tuned language model 310. In some embodiments, model trainer 115 re-trains language model 308 to adjust the parameters of language model 308 to improve the ability of language model 308 to generate descriptions of virtual environment states that are more aligned with actual user preferences included in user data 125, real-world developments included in event data 124, and/or human-in-the loop data 306, thereby creating fine-tuned language model 310. Any technically feasible training technique(s), such as backpropagation with gradient descent to minimize a next-token prediction loss, or a variation thereof, can be used in some embodiments. In addition or alternative to training/re-training language model 308, in some embodiments, zero-shot learning and/or few-shot learning can be employed, where language model 308 generates output descriptions based on structured prompts and/or rules instead of direct training examples. In some embodiments, the prompts can also be based on human-in-the-loop data 306, such as instructions or adjustments made by a person to control how language model 308 generates descriptions of virtual environment states. In some embodiments, prompt engineering can also be employed, where prompts are written or adjusted to guide language model 308 toward generating descriptions of virtual environment states that match the desired tone, style, and/or content for the virtual environment. The method 500 then returns to step 503 to receive new user data 125, event data 124, and/or human-in-the-loop data 306, assuming such data becomes available.

FIG. 6 is a flow diagram of method steps for generating a virtual environment, according to various embodiments. Although the method steps are described in conjunction with the systems of FIGS. 1-4, persons skilled in the art will understand that any system configured to perform the method steps in any order falls within the scope of the present embodiments.

As shown, a method 600 begins with step 601, where events aggregator 147 receives real-time feeds 180. In some embodiments, real-time feeds 180 are received via one or more I/O devices, an API, and/or the like. In some embodiments, real-time feeds 180 can originate from external systems, such as a theme park infrastructure, event scheduling systems, sensors, third-party data providers, or live content streams. In some embodiments, real-time feeds 180 can be transmitted over a network connection, such as network 130, and received by computing device 140 in any suitable format, such as JSON, XML, streaming protocols, proprietary data formats, and/or the like.

At step 602, events aggregator 147 generates aggregated events 402 based on real-time feeds 180. In some embodiments, aggregated events 402 represent specific happenings or conditions of interest. In some embodiments, events aggregator 147 routes different subsets of aggregated events 402 to one or more virtual environment instances, each of which corresponds, for example, to a separate game, simulation, or interactive narrative experience.

At step 603, relevance and prioritization agent 148 generates event data 403 based on aggregated events 402. In some embodiments, relevance and prioritization agent 148 evaluates aggregated events 402 based on predefined rules, author-defined importance levels, contextual filters, and/or trained machine learning models to determine which events are most significant or actionable for a given virtual environment. In some embodiments, relevance and prioritization agent 148 can include any technically feasible machine learning model, such as a learned ranking model, a language model, a multimodal model, a reasoning model, and/or the like. In some embodiments, relevance and prioritization agent 148 applies temporal filtering, location-based constraints, or thematic matching to permit that relevant and timely information is forwarded for use. Event data 403 includes the filtered and prioritized subset of aggregated events 402 that are deemed most relevant to the virtual environment generator 146. For example, event data 403 can include structured descriptions of selected events, context, and any metadata used for the orchestration of the virtual environment. In some embodiments, relevance and prioritization agent 148 is specific to a particular virtual environment generator application. In some other embodiments, relevance and prioritization agent 148 can be used across multiple different virtual environment generator applications.

At step 604, orchestrator agent 149 generates description of virtual environment state 406 based on event data 403, user input 404, and human-in-the-loop input 405. Although event data 403, user input 404, and human-in-the-loop input 405 are shown as being input into orchestrator agent 149 as a reference example, in some embodiments, orchestrator agent 149 can also receive any other suitable inputs, such as a current virtual environment state. Orchestrator agent 149 includes, without limitation, fine-tuned language model 310. In some embodiments, fine-tuned language model 310 can be trained and/or prompted to generate descriptions of virtual environment states, as described above in conjunction with FIG. 4. In such cases, orchestrator agent 149 uses fine-tuned language model 310 to generate a description of the virtual environment state 406 based on event data 403, user input 404, and human-in-the-loop input 405 and formats the inputs into a consistent output, namely description of virtual environment state 406, that reflects what has to be displayed or updated in the virtual environment. In some embodiments, orchestrator agent 149 can be configured to generate virtual environment states for any suitable game, such as anything from scripted but dynamically generated and interactive story worlds to open-world game environments that offer users greater freedom in exploring and engaging with the game world. In some embodiments, orchestrator agent 149 handles the scripting and narrative of a game, such as guiding the game along a pre-scripted storyline. In some embodiments, fine-tuned language model 310 receives as input a combination of event data 403, user input 404, and human-in-the-loop input 405 along with any relevant prior virtual environment state information. Orchestrator agent 149 uses fine-tuned language model 310 to process event data 403, user input 404, and human-in-the-loop input 405 using a prompt or template that defines the format and scope of the output description of virtual environment state 406.

At step 605, environment generator agent 150 generates updated virtual environment 407 based on description of virtual environment state 406. In some embodiments, environment generator agent 150 parses description of virtual environment state 406 to identify which elements need to be added, removed, modified, or animated. For example, environment generator agent 150 could determine which assets to load, what actions occur, where to place the assets in a scene, what animations or effects to trigger, and how to update interactions between characters or objects. In some embodiments, environment generator agent 150 uses a generative AI model, game engine, rendering engine, content scripting system, and/or the like to apply the changes and generate updated virtual environment 407. For example, in some embodiments, the generative AI model can be an open world model that generates a next video frame conditioned on inputs provided by the environment generator agent 150, such as a current video frame, assets to place within the virtual environment, and user input. In such cases, the open world model can have any technically feasible architecture (e.g., a transformer-based architecture) and be trained using any suitable data. For example, the open world model and/or one or more adapters (e.g., LoRA) that are added to the open world model could be trained and/or fine-tuned to permit conditioning of generated inputs on text descriptions of virtual environment states that are output by orchestrator agent 149, and the open world model and/or adapter(s) could be further trained using example images, film footage, and/or the like to generate desired virtual environments and/or assets therein (e.g., themed worlds, specific characters, artistic styles, etc.). Further, the generative AI model can be invoked to update the virtual environment at any suitable frequency, such as every frame, every second, or the like. As another example, in some embodiments, the generative AI model can be used to create or enhance assets, such as textures, animations, background elements, or filler characters based on the description of the virtual environment state 406. In such cases, the assets can be placed within the virtual environment using a game engine, the generative AI model itself, and/or the like, and the assets could also be controlled within the virtual environment by environment generator agent 150. In some embodiments, virtual environment generator 146 can also include one or more moderation agents and/or models that check the outputs of relevance and prioritization agent 148, orchestrator agent 149, and/or environment generator agent 150 using rules or policies to ensure that desired outputs are being generated. For example, if relevance and prioritization agent 148 outputs negative events that should not be used to update a virtual environment, then the moderation agent(s) and/or model(s) could modify or otherwise prevent the negative events from being processed by orchestrator agent 149. As another example, if orchestrator agent 149 outputs a negative description of a virtual environment state that should not be generated, then the moderation agent(s) and/or model(s) could modify the description of the virtual environment state 406. Once generated, the updated virtual environment 407 can be output to one or more users using any technically feasible output device(s). For example, if the environment generator agent 150 generates video frames of the updated virtual environment 407, the video frames could be output via a display device and associated audio could be output via a speaker device. As another example, if the environment generator agent 150 generates the updated virtual environment 407 as an XR environment, such as an augmented reality AR, VR, or MR environment, the XR environment could be output via an XR headset.

In sum, techniques are disclosed for generating virtual environments based on real-time events. In some embodiments, a virtual environment generator application includes an ensemble of agents that operate together to translate real-time events and user inputs into changes in a virtual environment generated by the agents. The agents can include a relevance and prioritization agent, an orchestrator agent, and an environment generator agent. Initially, an events aggregator receives and aggregates one or more real-time feeds to generate aggregated events. The real-time feeds can include data from live sports events, theme park sensors, crowd analytics, weather conditions, and/or other external sources. The relevance and prioritization agent parses the aggregated events and outputs, in a predefined format, real-world event data from the real-time feeds that is relevant to generating a virtual environment, such as the virtual environment for a particular game. The orchestrator agent receives the event data output by the relevance and prioritization agent as well as user input, and the orchestrator agent outputs a description of the virtual environment state to generate. In some embodiments, the orchestrator agent can prompt a language model, which is trained using data about the virtual environment including rules and/or media content, to process the event data and to generate the description of the virtual environment state. In some embodiments, the data about the virtual environment can include story templates, character descriptions, environmental themes, environment physics, and/or the like. The language model can be continuously or periodically re-trained, such as using user data, human-in-the-loop, and/or event data that has been collected. The user data can include user profiles, historical behaviors of users, engagement patterns, and/or the like. Once trained, the language model can generate descriptions of virtual environment states which include coherent and thematically appropriate dialogue, plotlines, narrative branches, and/or the like. that are based on real-time events and user input. The environment generator agent processes the description of the virtual environment state and generates an updated virtual environment that reflects the virtual environment state. In some embodiments, the environment generator agent can input data relevant to the virtual environment state into a video generative model, game engine, and/or the like that then generates the updated virtual environment.

At least one technical advantage of the disclosed techniques relative to the prior art is that the disclosed techniques permit virtual environments to dynamically respond to real-time physical events. Unlike conventional approaches where the virtual environment remains static with respect to physical events once manually programmed or generated by a machine learning model, the disclosed techniques utilize an ensemble of agents as well as a fine-tuned language model to continuously update the virtual environment based on real-time feeds of physical events and optionally human-in-the-loop inputs. These technical advantages represent one or more technological improvements over prior art approaches.
1. In some embodiments, a computer-implemented method for generating a virtual environment comprises receiving one or more real-time feeds and one or more user inputs, generating, using a first trained machine learning model and based on the one or more real-time feeds and the user input, a description of a virtual environment state, generating, based on the description of the virtual environment state, the virtual environment, and outputting the virtual environment via at least one output device.
2. The computer-implemented method of clause 1, further comprising performing, based on at least one of media content or a set of rules, one or more training operations to generate a second trained machine learning model, and performing, based on at least one of user data, data associated with one or more physical events, or data associated with one or more operator inputs, one or more training operations to re-train the second trained machine learning model to generate the first trained machine learning model.
3. The computer-implemented method of clauses 1 or 2, wherein the set of rules includes at least one of one or more design rules that guide generation of content within the virtual environment, or one or more technical rules that define at least one of how the first trained machine learning model operates or how the first trained machine learning model interacts with a second trained machine learning model.
4. The computer-implemented method of any of clauses 1-3, wherein generating the description of the virtual environment state comprises generating, based on the one or more real-time feeds, event data, and generating, using the first trained machine learning model and based on the event data and the user input, the description of the virtual environment state.
5. The computer-implemented method of any of clauses 1-4, wherein generating the event data is based on at least one of one or more predefined rules, one or more importance levels, one or more contextual filters, or one or more ranking models.
6. The computer-implemented method of any of clauses 1-5, wherein the virtual environment is generated using a second trained machine learning model.
7. The computer-implemented method of any of clauses 1-6, wherein the second trained machine learning model comprises a trained open world model.
8. The computer-implemented method of any of clauses 1-7, wherein generating the virtual environment comprises parsing the description of the virtual environment state to identify at least one or more objects to at least one of add, remove, modify, or animate within the virtual environment.
9. The computer-implemented method of any of clauses 1-8, wherein the one or more real-time feeds are from at least one of an event scheduling system, one or more sensors, one or more application programming interfaces (APIs), or one or more live content streams.
10.The computer-implemented method of any of clauses 1-9, wherein the virtual environment is generated using at least one of a generative artificial intelligence (AI) model, a game engine, a rendering engine, or a content scripting system.
11.In some embodiments, one or more non-transitory computer-readable media store instructions that, when executed by one or more processors, cause the one or more processors to perform the steps of receiving one or more real-time feeds and one or more user inputs, generating, using a first trained machine learning model and based on the one or more real-time feeds and the user input, a description of a virtual environment state, generating, based on the description of the virtual environment state, the virtual environment, and outputting the virtual environment via at least one output device.
12.The one or more non-transitory computer-readable media of clause 11, wherein the instructions, when executed by the one or more processors, further cause the one or more processors to perform the steps of performing, based on at least one of media content or a set of rules, one or more training operations to generate a second trained machine learning model, and performing, based on at least one of user data, data associated with one or more physical events, or data associated with one or more operator inputs, one or more training operations to re-train the second trained machine learning model to generate the first trained machine learning model.
13.The one or more non-transitory computer-readable media of clauses 11 or 12, wherein the set of rules includes at least one of one or more design rules that guide generation of content within the virtual environment, or one or more technical rules that define at least one of how the first trained machine learning model operates or how the first trained machine learning model interacts with a second trained machine learning model.
14.The one or more non-transitory computer-readable media of any of clauses 11-13, wherein generating the description of the virtual environment state comprises generating, based on the one or more real-time feeds, event data, and generating, using the first trained machine learning model and based on the event data and the user input, the description of the virtual environment state.
15.The one or more non-transitory computer-readable media of any of clauses 11-14, wherein the virtual environment is generated using a second trained machine learning model.
16.The one or more non-transitory computer-readable media of any of clauses 11-15, wherein the second trained machine learning model comprises a trained open world model.
17.The one or more non-transitory computer-readable media of any of clauses 11-16, wherein the instructions, when executed by the one or more processors, further cause the one or more processors to perform the step of modifying, via a moderation agent, at least one of an event included in the one or more real-time feeds or a portion of the description of the virtual environment state.
18.The one or more non-transitory computer-readable media of any of clauses 11-17, wherein the description of the virtual environment state is generated by at least one first agent, and the virtual environment is generated by at least one second agent.
19.The one or more non-transitory computer-readable media of any of clauses 11-18, wherein generating the description of the virtual environment state is further based on one or more operator inputs.
20. In some embodiments, a system comprises one or more memories storing instructions, and one or more processors that are coupled to the one or more memories and, when executing the instructions, are configured to receive one or more real-time feeds and one or more user inputs, generate, using a first trained machine learning model and based on the one or more real-time feeds and the user input, a description of a virtual environment state, generate, based on the description of the virtual environment state, the virtual environment, and output the virtual environment via at least one output device.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating a virtual environment, the method comprising:
receiving one or more real-time feeds and one or more user inputs;
generating, using a first trained machine learning model and based on the one or more real-time feeds and the user input, a description of a virtual environment state;
generating, based on the description of the virtual environment state, the virtual environment; and
outputting the virtual environment via at least one output device.

2. The computer-implemented method of claim 1, further comprising:
performing, based on at least one of media content or a set of rules, one or more training operations to generate a second trained machine learning model; and
performing, based on at least one of user data, data associated with one or more physical events, or data associated with one or more operator inputs, one or more training operations to re-train the second trained machine learning model to generate the first trained machine learning model.

3. The computer-implemented method of claim 2, wherein the set of rules includes at least one of:
one or more design rules that guide generation of content within the virtual environment; or
one or more technical rules that define at least one of how the first trained machine learning model operates or how the first trained machine learning model interacts with a second trained machine learning model.

4. The computer-implemented method of claim 1, wherein generating the description of the virtual environment state comprises:
generating, based on the one or more real-time feeds, event data; and
generating, using the first trained machine learning model and based on the event data and the user input, the description of the virtual environment state.

5. The computer-implemented method of claim 4, wherein generating the event data is based on at least one of one or more predefined rules, one or more importance levels, one or more contextual filters, or one or more ranking models.

6. The computer-implemented method of claim 1, wherein the virtual environment is generated using a second trained machine learning model.

7. The computer-implemented method of claim 6, wherein the second trained machine learning model comprises a trained open world model.

8. The computer-implemented method of claim 1, wherein generating the virtual environment comprises parsing the description of the virtual environment state to identify at least one or more objects to at least one of add, remove, modify, or animate within the virtual environment.

9. The computer-implemented method of claim 1, wherein the one or more real-time feeds are from at least one of an event scheduling system, one or more sensors, one or more application programming interfaces (APIs), or one or more live content streams.

10. The computer-implemented method of claim 1, wherein the virtual environment is generated using at least one of a generative artificial intelligence (AI) model, a game engine, a rendering engine, or a content scripting system.

11. One or more non-transitory computer-readable media storing instructions that, when executed by one or more processors, cause the one or more processors to perform the steps of:
receiving one or more real-time feeds and one or more user inputs;
generating, using a first trained machine learning model and based on the one or more real-time feeds and the user input, a description of a virtual environment state;
generating, based on the description of the virtual environment state, the virtual environment; and
outputting the virtual environment via at least one output device.

12. The one or more non-transitory computer-readable media of claim 11, wherein the instructions, when executed by the one or more processors, further cause the one or more processors to perform the steps of:
performing, based on at least one of media content or a set of rules, one or more training operations to generate a second trained machine learning model; and
performing, based on at least one of user data, data associated with one or more physical events, or data associated with one or more operator inputs, one or more training operations to re-train the second trained machine learning model to generate the first trained machine learning model.

13. The one or more non-transitory computer-readable media of claim 12, wherein the set of rules includes at least one of:
one or more design rules that guide generation of content within the virtual environment; or
one or more technical rules that define at least one of how the first trained machine learning model operates or how the first trained machine learning model interacts with a second trained machine learning model.

14. The one or more non-transitory computer-readable media of claim 11, wherein generating the description of the virtual environment state comprises:
generating, based on the one or more real-time feeds, event data; and
generating, using the first trained machine learning model and based on the event data and the user input, the description of the virtual environment state.

15. The one or more non-transitory computer-readable media of claim 11, wherein the virtual environment is generated using a second trained machine learning model.

16. The one or more non-transitory computer-readable media of claim 15, wherein the second trained machine learning model comprises a trained open world model.

17. The one or more non-transitory computer-readable media of claim 11, wherein the instructions, when executed by the one or more processors, further cause the one or more processors to perform the step of modifying, via a moderation agent, at least one of an event included in the one or more real-time feeds or a portion of the description of the virtual environment state.

18. The one or more non-transitory computer-readable media of claim 11, wherein the description of the virtual environment state is generated by at least one first agent, and the virtual environment is generated by at least one second agent.

19. The one or more non-transitory computer-readable media of claim 11, wherein generating the description of the virtual environment state is further based on one or more operator inputs.

20. A system comprising:
one or more memories storing instructions, and
one or more processors that are coupled to the one or more memories and,
when executing the instructions, are configured to:
receive one or more real-time feeds and one or more user inputs,
generate, using a first trained machine learning model and based on the one or more real-time feeds and the user input, a description of a virtual environment state,
generate, based on the description of the virtual environment state, the virtual environment, and
output the virtual environment via at least one output device.
